(19) United States
(12) Patent Application Publication
(10) Pub. No.: US 2026/0162898 A1
(43) Pub. Date: Jun. 11, 2026

(54) MULTILAYER CERAMIC CAPACITOR

(71) Applicant: Murata Manufacturing Co., Ltd., Nagaokakyo-shi (JP)

(72) Inventor: Takashi DEGURA, Nagaokakyo-shi (JP)

(21) Appl. No.: 19/372,433

(22) Filed: Oct. 29, 2025

(30) Foreign Application Priority Data
Dec. 6, 2024 (JP) 2024-213869

(51) Int. Cl. H01G 4/12; H01G 4/30

(52) U.S. Cl. CPC H01G 4/1236; H01G 4/30

(57) ABSTRACT

A multilayer ceramic capacitor includes a multilayer body and a pair of outer electrodes arranged in a length direction. The multilayer body includes an inner layer portion including effective portions and an inner dielectric layer, and a pair of outer layer portions between which the inner layer portion is arranged in a lamination direction. A dimension of the multilayer body in a width direction is greater than a dimension of the multilayer body in the length direction. The inner electrodes include Cu. The dielectric body includes Zr and an alkaline earth metal element that is at least one of Ca or Sr. The inner dielectric layer includes inner-layer Zr-rich regions. The outer layer portions include outer-layer Zr-rich regions.

### CROSS REFERENCE TO RELATED APPLICATIONS

This application claims the benefit of priority to Japanese Patent Application No. 2024-213869 filed on Dec. 6, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

An existing multilayer ceramic capacitor includes an inner layer portion, in which a plurality of dielectric layers and inner electrodes are laminated, and outer layer portions between which the inner layer portion is disposed. Some multilayer ceramic capacitors have good high frequency characteristics (for example, Japanese Unexamined Patent Application Publication No. 2001-338829).

A multilayer ceramic capacitor according to Japanese Unexamined Patent Application Publication No. 2001-338829 includes inner electrodes including Cu as the main component. This enables a reduction in signal loss in high frequency regions because Cu has a relatively low specific resistance.

### SUMMARY OF THE INVENTION

However, there may be a relatively large difference in contractibility between the inner layer portion including the inner electrodes including Cu, which has a relatively high coefficient of linear expansion, and the outer layer portions including no inner electrodes. Accordingly, boundaries between the inner layer portion and the outer layer portions may be prone to structural defects, such as separations and cracks.

Accordingly, example embodiments of the present invention provide multilayer ceramic capacitors with less occurrence of structural defects.

A multilayer ceramic capacitor according to an example embodiment of the present invention includes a multilayer body and a pair of outer electrodes. The multilayer body includes a dielectric body and a plurality of inner electrodes laminated with the dielectric body therebetween. The multilayer body includes a first principal surface and a second principal surface that face each other in a lamination direction, a first side surface and a second side surface that face each other in a width direction orthogonal to the lamination direction, and a first end surface and a second end surface that face each other in a length direction orthogonal to the lamination direction and the width direction. The outer electrodes are arranged in the length direction as a pair, each of the outer electrodes being connected to the inner electrodes. The multilayer body includes an inner layer portion and a pair of outer layer portions between which the inner layer portion is arranged in the lamination direction. The inner layer portion includes effective portions, which are portions of adjacent ones of the inner electrodes that face each other, and an inner dielectric layer, which is a portion of the dielectric body between adjacent ones of the effective portions. A dimension of the multilayer body in the width direction is greater than a dimension of the multilayer body in the length direction. The inner electrodes include Cu. The dielectric body includes Zr and an alkaline earth metal element that is at least one of Ca or Sr. The inner dielectric layer includes inner-layer Zr-rich regions. The outer layer portions include outer-layer Zr-rich regions.

According to example embodiments of th present invention, multilayer ceramic capacitors with less occurrence of structural defects can be provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a sectional view of FIG. 1 taken along line II-II.

FIG. 3 is a sectional view of FIG. 1 taken along line III-III.

FIG. 4 is an enlarged view of part IV in FIG. 2.

FIG. 5 is an enlarged view of part V in FIG. 2.

### DETAILED DESCRIPTION OF THE EXAMPLE EMBODIMENTS

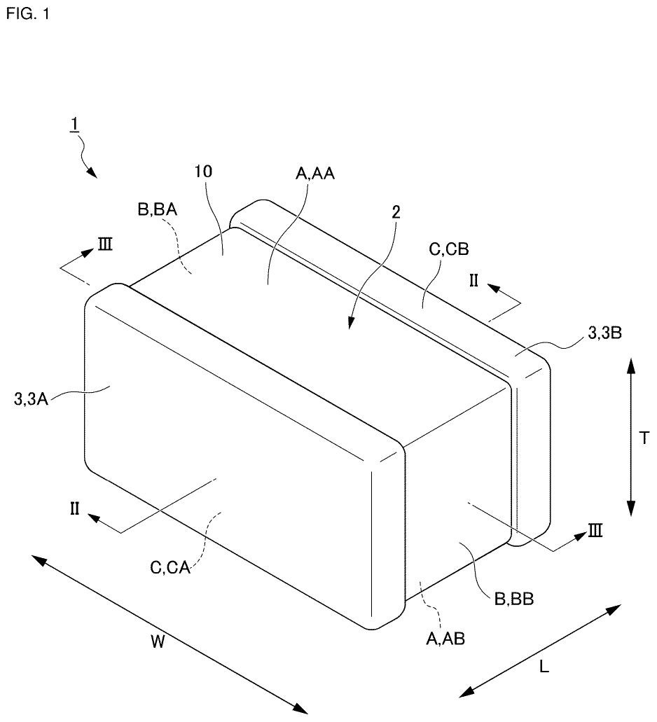

Multilayer ceramic capacitors according to example embodiments of the present invention will be described with reference to FIGS. 1 to 5.

As illustrated in FIG. 1, the multilayer ceramic capacitor 1 is a two-terminal multilayer ceramic capacitor, for example. The multilayer ceramic capacitor 1 is an LW-reversed multilayer ceramic capacitor. The multilayer ceramic capacitor 1 includes a multilayer body 2 and a pair of outer electrodes 3. The multilayer body 2 is substantially rectangular-parallelepiped-shaped and has six outer surfaces. The multilayer body 2 includes a dielectric body 10 and a plurality of inner electrodes 15 laminated with the dielectric body 10 therebetween.

In this specification, a direction in which the dielectric body 10 and the inner electrodes 15 are laminated in the multilayer ceramic capacitor 1 is referred to as a lamination direction T. A direction orthogonal to the lamination direction T is referred to as a length direction L. A direction orthogonal to both the length direction L and the lamination direction T is referred to as a width direction W.

Of the six outer surfaces of the multilayer body 2, a pair of outer surfaces at both sides in the lamination direction T is referred to as a first principal surface AA and a second principal surface AB, a pair of outer surfaces extending in the lamination direction T at both sides in the width direction W as a first side surface BA and a second side surface BB, and a pair of outer surfaces extending in the lamination direction T at both sides in the length direction L as a first end surface CA and a second end surface CB.

The first principal surface AA and the second principal surface AB may be referred to collectively as “principal surfaces A”. The first side surface BA and the second side surface BB may be referred to collectively as “side surfaces B”. The first end surface CA and the second end surface CB may be referred to collectively as “end surfaces C”.

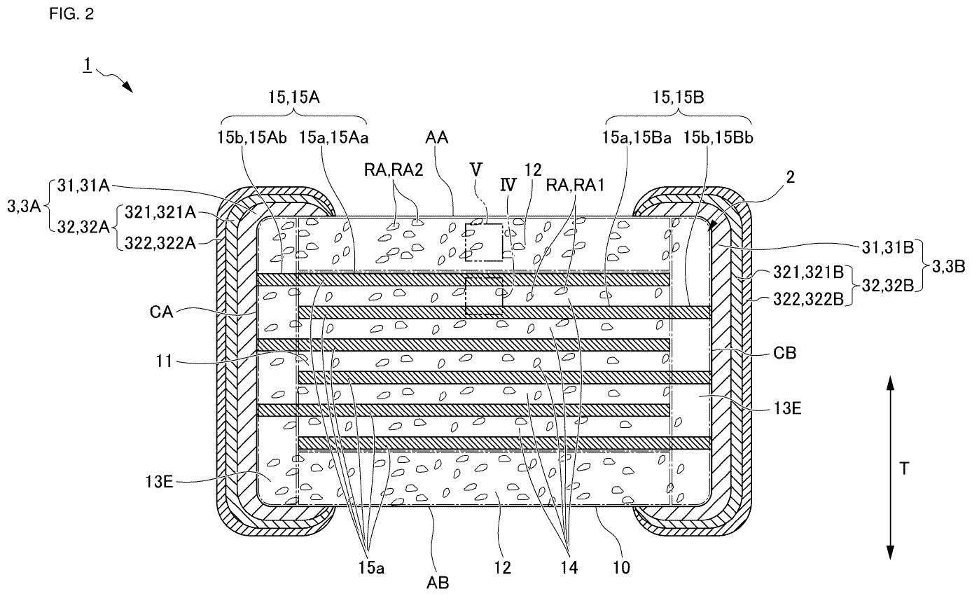

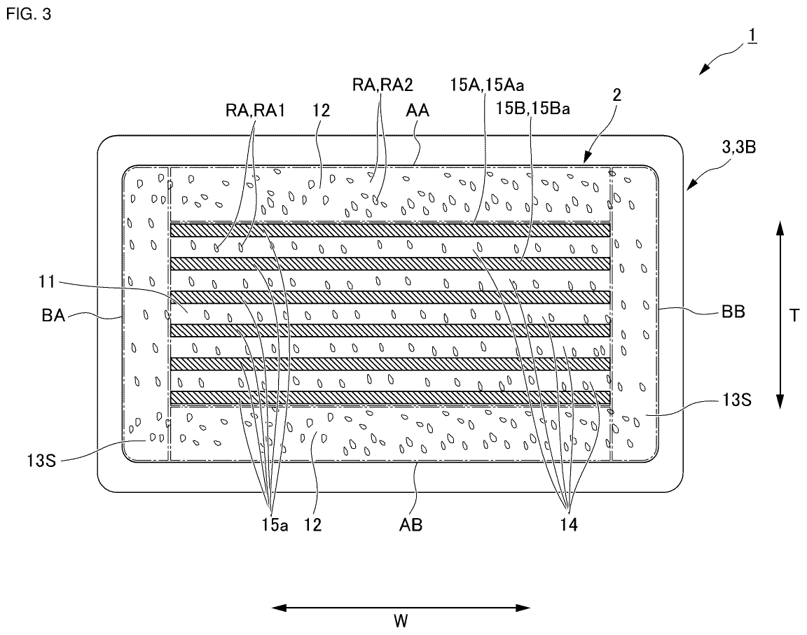

A cross section along a plane parallel to the lamination direction T and the length direction L is referred to as an “LT cross section”. The cross section of FIG. 2 is an LT cross section passing through a central portion of the multilayer ceramic capacitor 1 in the width direction W. A cross section along a plane parallel to the lamination direction T and the width direction W is referred to as a “WT cross section”. The cross section of FIG. 3 is a WT cross section passing through a central portion of the multilayer ceramic capacitor 1 in the length direction L.

The multilayer body 2 is substantially rectangular-parallelepiped-shaped. The dimension of the multilayer body 2 in the width direction W is greater than the dimension of the multilayer body 2 in the length direction L. The dimension of the multilayer body 2 in the length direction L is, for example, about 0.2 mm or more and about 2.2 mm or less. The dimension of the multilayer body 2 in the width direction W is, for example, about 0.1 mm or more and about 1.5 mm or less. The dimension of the multilayer body 2 in the lamination direction T is, for example, about 0.1 mm or more and about 1.0 mm or less. The outer dimensions of the multilayer ceramic capacitor 1 can be measured with a micrometer.

Portions of the multilayer body 2 at which three outer surfaces intersect are referred to as “corner portions”. Portions of the multilayer body 2 at which two outer surfaces intersect are referred to as “ridge portions”. The corner portions and the ridge portions of the multilayer body 2 are preferably rounded.

As illustrated in FIGS. 2 and 3, the multilayer body 2 includes the dielectric body 10 and the inner electrodes 15.

The dielectric body 10 is substantially rectangular-parallelepiped-shaped as a whole. The main component of the dielectric body 10 is, for example, a ceramic including at least one of Ca, Sr, Zr, or Ti. The main component of the dielectric body 10 is a dielectric ceramic having a perovskite structure including Ca and Zr and represented by the general formula ABO₃. The main component of the dielectric body 10 is, for example, a compound oxide having a composition represented by (Ca₁₋ₓ, Srₓ)m(Zr_{1-z}, Ti_{z})O₃, where x is 0 or more and 1 or less, m is about 1.0 or more and about 1.1 or less, and z is about 0 or more and about 0.2 or less. The main component of the dielectric body 10 is, for example, CaZrO₃ (calcium zirconate). The dielectric body 10 may include, for example, CaTiO₃ (calcium titanate), SrTiO₃ (strontium titanate), BaZrO₃ (proton-conductive metal oxide), and titanium oxide (TiO₂). The main component of the dielectric body is a component of the dielectric body with a content of about 50 percent by mass or more, for example.

The main component of the ceramic material that forms the dielectric body 10 may include all of Ca, Zr, and Ti. For example, the dielectric body 10 may be Ca(Zr_{0.9}Ti_{0.1})O₃, which is a substance in which ZrO₃ or Zr in CaZrO₃ is partially replaced by Ti. The dielectric body 10 may include all of Ca, Zr, and Ti. For example, the dielectric body 10 may include Ca(Zr_{0.9}Ti_{0.1})O₃, which is a substance in which ZrO₃ or Zr in CaZrO₃ is partially replaced by Ti.

The dielectric body 10 includes glass including, for example, Si oxide, Li, B, Na, and K. The sintering temperature of the multilayer body 2 can be adjusted by adjusting the amount of glass included in the dielectric body 10.

The dielectric body 10 may include additives. Examples of the additives include Mn, Mg, Dy, and Cr, oxides of rare earths such as V, Sm, Eu, Gd, Tb, Ho, Er, Tm, Yb, and Y, and Co and Ni.

The inner electrodes 15 are provided in the dielectric body 10. The inner electrodes 15 are arranged at intervals in the lamination direction T. Layer-shaped portions of the dielectric body 10 are between adjacent ones of the inner electrodes 15. In other words, the inner electrodes 15 and portions of the dielectric body 10 are laminated in the lamination direction T. The total number of inner electrodes 15 is, for example, one or more and 100 or less.

Of metals including Ni, Cu, Ag, Pd, an Ag—Pd alloy, Au, and Sn, at least Cu is included in the inner electrodes 15. The main component of the inner electrodes is Cu. The inner electrodes 15 are formed by sintering, on a dielectric sheet, a conductive paste including metal powder to serve as a conductor, an organic solvent, a binder, and a dispersant. The main component of the inner electrodes is a component of the inner electrodes with a content of 50 percent by mass or more.

The inner electrodes 15 include a plurality of first inner electrodes 15A and a plurality of second inner electrodes 15B. The first inner electrodes 15A and the second inner electrodes 15B are, for example, arranged alternately.

The first inner electrodes 15A are exposed at the first end surface CA. Each first inner electrode 15A includes a first effective portion 15Aa and a first extended portion 15Ab. The first effective portion 15Aa is a portion of the first inner electrode 15A that faces a second inner electrode 15B adjacent to the first inner electrode 15A. The first extended portion 15Ab is a portion of the first inner electrode 15A that extends from the first effective portion 15Aa toward the first end surface CA.

The second inner electrodes 15B are exposed at the second end surface CB. Each second inner electrode 15B includes a second effective portion 15Ba and a second extended portion 15Bb. The second effective portion 15Ba is a portion of the second inner electrode 15B that faces a first inner electrode 15A (first effective portion 15Aa) adjacent to the second inner electrode 15B. The second extended portion 15Bb is a portion of the second inner electrode 15B that extends from the second effective portion 15Ba toward the second end surface CB.

The first inner electrodes 15A and the second inner electrodes 15B may be referred to collectively as the “inner electrodes 15”. The first effective portions 15Aa and the second effective portions 15Ba may be referred to collectively as “effective portions 15a”.

The multilayer body 2 includes an inner layer portion 11, a pair of outer layer portions 12 between which the inner layer portion 11 is disposed in the lamination direction T, a pair of side gap portions 13S between which the inner layer portion 11 and the outer layer portions 12 are disposed in the width direction W, and a pair of end gap portions 13E between which the inner layer portion 11 and the outer layer portions 12 are disposed in the length direction L.

The inner layer portion 11 is a portion of the multilayer body 2 including the effective portions 15a and inner dielectric layers 14, which are portions of the dielectric body 10 between adjacent ones of the effective portions 15a. In the inner layer portion 11, the first effective portions 15Aa and the second effective portions 15Ba face each other with the inner dielectric layers 14 therebetween. The thus-formed portion generates an electrostatic capacitance.

The outer layer portions 12 include a portion of the multilayer body 2 between the inner layer portion 11 and the first principal surface AA and a portion of the multilayer body 2 between the inner layer portion 11 and the second principal surface AB. The outer layer portions 12 include portions of the dielectric body 10. The outer layer portions 12 are made of a dielectric ceramic. No inner electrodes 15 are provided in the outer layer portions 12.

The side gap portions 13S include a portion of the multilayer body 2 between the inner layer portion 11 and the first side surface BA and a portion of the multilayer body 2 between the inner layer portion 11 and the second side surface BB. The side gap portions 13S include portions of the dielectric body 10. No inner electrodes 15 are provided in the side gap portions 13S.

The end gap portions 13E include a portion of the multilayer body 2 between the inner layer portion 11 and the first end surface CA and a portion of the multilayer body 2 between the inner layer portion 11 and the second end surface CB. One of the pair of end gap portions 13E includes portions of the dielectric body 10 and the first extended portions 15Ab. The other includes portions of the dielectric body 10 and the second extended portions 15Bb.

The outer electrodes 3 are provided on the multilayer body 2. The outer electrodes 3 are arranged in the length direction L as a pair. The outer electrodes 3 are connected to the inner electrodes 15. The outer electrodes 3 include a first outer electrode 3A and a second outer electrode 3B.

The first outer electrode 3A is provided on the first end surface CA and is connected to the first inner electrodes 15A. The first outer electrode 3A, for example, covers not only the first end surface CA but also portions of the principal surfaces A and portions of the side surfaces B. The first outer electrode 3A includes a first base electrode layer 31A and a first plating layer 32A provided on the first base electrode layer 31A. The first plating layer 32A includes a first inner plating layer 321A provided on the first base electrode layer 31A and a first outer plating layer 322A provided on the first inner plating layer 321A.

The second outer electrode 3B is provided on the second end surface CB and is connected to the second inner electrodes 15B. The second outer electrode 3B, for example, covers not only the second end surface CB but also portions of the principal surfaces A and portions of the side surfaces B. The second outer electrode 3B includes a second base electrode layer 31B and a second plating layer 32B provided on the second base electrode layer 31B. The second plating layer 32B includes a second inner plating layer 321B provided on the second base electrode layer 31B and a second outer plating layer 322B provided on the second inner plating layer 321B.

The first base electrode layer 31A and the second base electrode layer 31B may be referred to collectively as “base electrode layers 31”. The first plating layer 32A and the second plating layer 32B may be referred to collectively as “plating layers 32”. The first inner plating layer 321A and the second inner plating layer 321B may be referred to collectively as “inner plating layers 321”. The first outer plating layer 322A and the second outer plating layer 322B may be referred to collectively as “outer plating layers 322”.

The outer electrodes 3 include the base electrode layers 31 provided on the surfaces of the multilayer body 2 and the plating layers 32 provided on the base electrode layers 31.

The base electrode layers 31 include a conductive metal, such as Cu, Ni, Ag, Pd, Au, or an Ag—Pd alloy, as the main component. The base electrode layers 31 preferably include Cu as the main component. The base electrode layers 31 are, for example, baked layers including a conductive metal and glass. The main component of the base electrode layers is a component of the base electrode layers with a content of 50 percent by mass or more.

The plating layers 32 are, for example, made of a metal selected from the group consisting of Cu, Ni, Ag, Pd, Au, and Sn, or an alloy including the metal. The plating layers 32 include, for example, the inner plating layers 321 provided on the base electrode layers 31 and the outer plating layers 322 provided on the inner plating layers 321. The inner plating layers 321 are, for example, Ni plating layers. The outer plating layers 322 are, for example, Sn (tin) plating layers. The plating layers 32 may have a single layer structure.

The dimension of the multilayer body 2 in the width direction W is greater than the dimension of the multilayer body 2 in the length direction L. The inner electrodes 15 include Cu. The dielectric body 10 includes Zr and an alkaline earth metal element that is at least one of Ca or Sr.

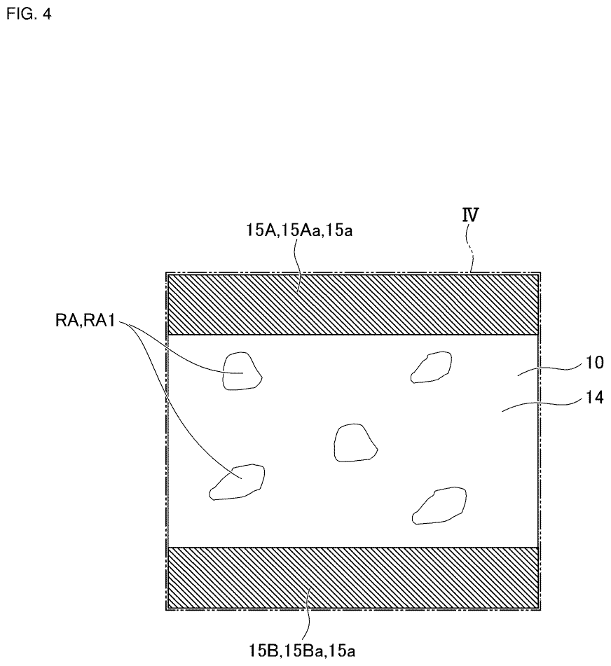

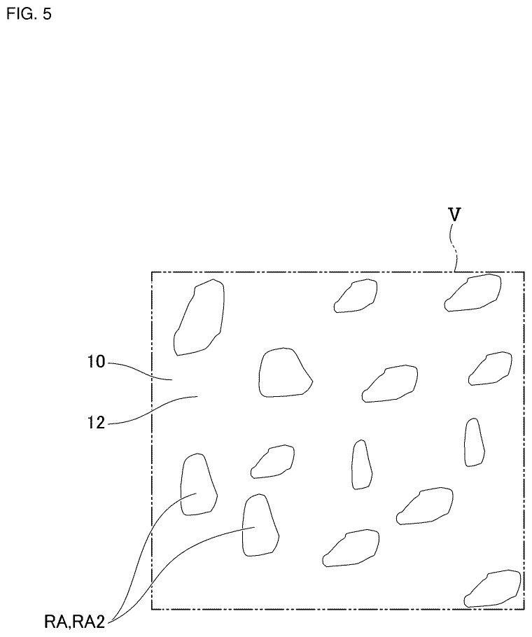

As illustrated in FIG. 4, the inner dielectric layers 14 include inner-layer Zr-rich regions RA1. As illustrated in FIG. 5, the outer layer portions 12 include outer-layer Zr-rich regions RA2. The inner-layer Zr-rich regions RA1 and the outer-layer Zr-rich regions RA2 may be referred to collectively as “Zr-rich regions RA”.

In an LT cross section passing through a central portion of the multilayer ceramic capacitor in the width direction W, the “Zr-rich regions” are regions of the dielectric body 10 that satisfy both conditions (A) and (B) given below:

Regions in which both Zr and an alkaline earth metal element are included and in which the content of the alkaline earth metal element is about ¼ or less of the content of Zr (A); and

Regions having a maximum region diameter of about 500 nm or more (B).

The “maximum region diameter” of a region is the distance between two parallel straight lines between which the region is in contact with the straight lines such that the distance between the straight lines is at a maximum.

The content of a metal element in the dielectric body 10 is measured by, for example, an energy dispersive X-ray spectroscopy (TEM-EDX).

The alkaline earth metal element included in the dielectric body 10 is, for example, Ca. The dielectric body 10 includes, for example, a compound oxide including Zr and Ca.

More specifically, the dielectric body 10 includes a compound oxide including Zr and Ca and having a composition represented by (Ca₁₋ₓ, Srₓ)m(Zr_{1-z}, Ti_{z})O₃, where x is 0 or more and 1 or less, m is 1.0 or more and 1.1 or less, and z is about 0 or more and about 0.2 or less, for example.

For example, the inner dielectric layers 14 include a compound oxide including Zr and Ca. The outer layer portions 12 include a compound oxide including Zr and Ca.

The alkaline earth metal element included in the dielectric body 10 may be Sr, and the dielectric body 10 may include a compound oxide including Zr, Ti, and Sr. The content ratio of Zr in the dielectric body 10 may be greater than the content ratio of Ti in the dielectric body 10.

For example, the inner dielectric layers 14 may include a compound oxide including Zr, Ti, and Sr, and the content ratio of Zr in the inner dielectric layers 14 may be greater than the content ratio of Ti in the inner dielectric layers 14. The outer layer portions 12 may include a compound oxide including Zr, Ti, and Sr, and the content ratio of Zr in the outer layer portions 12 may be greater than the content ratio of Ti in the outer layer portions 12.

The dielectric body 10 includes at least one of Li, Na, Mn, B, or Si.

For example, the inner dielectric layers 14 include at least one of Li, Na, Mn, B, or Si. The outer layer portions 12 include at least one of Li, Na, Mn, B, or Si.

The outer electrodes 3 (more specifically, the base electrode layers 31) include Cu.

For example, the first outer electrode 3A (more specifically, the first base electrode layer 31A) includes Cu. The second outer electrode 3B (more specifically, the second base electrode layer 31B) includes Cu.

The area of the inner-layer Zr-rich regions RA1 per unit area of the inner dielectric layers 14 is less than the area of the outer-layer Zr-rich regions RA2 per unit area of the outer layer portions 12.

The area of the inner-layer Zr-rich regions per unit area of the inner dielectric layers may be referred to simply as an “area proportion of the inner-layer Zr-rich regions”. The area of the outer-layer Zr-rich regions per unit area of the outer layer portions may be referred to simply as an “area proportion of the outer-layer Zr-rich regions”. The area proportion of the inner-layer Zr-rich regions and the area proportion of the outer-layer Zr-rich regions may be referred to collectively as an “area proportion of the Zr-rich regions”. The area proportion of the Zr-rich regions is the area of the Zr-rich regions per unit area of the dielectric body.

The area proportion of the Zr-rich regions is a value obtained by dividing the total area of the Zr-rich regions in a field of view by the total area of the dielectric body in the field of view. The field of view is, for example, about 0.1 μm x about 0.1 μm.

The ratio of the area of the inner-layer Zr-rich regions RA1 per unit area of the inner dielectric layers 14 to the area of the outer-layer Zr-rich regions RA2 per unit area of the outer layer portions 12 is about 0.05 or more and about 0.9 or less, for example.

The ratio of the area of the inner-layer Zr-rich regions RA1 per unit area of the inner dielectric layers 14 to the area of the outer-layer Zr-rich regions RA2 per unit area of the outer layer portions 12 may be referred to simply as an “area ratio of the Zr-rich regions”. In other words, the area ratio of the Zr-rich regions is a value obtained by dividing the area proportion of the inner-layer Zr-rich regions by the area proportion of the outer-layer Zr-rich regions.

A non-limiting example of a method for manufacturing the multilayer ceramic capacitor 1 according to the example embodiment will now be described.

First, ceramic slurry is prepared as the material of dielectric sheets. Ceramic slurry for the dielectric body includes not only a ceramic raw material including a dielectric ceramic but also a binder and a solvent.

Examples of the material that serves as the ceramic raw material include powders of CaZrO₃, SrZrO₃, SrTiO₃, and CaTio₃. The powders are obtained, for example, by subjecting powders serving as raw materials to wet-blending, drying, baking at a predetermined temperature in air, and pulverizing. The raw material of the CaZrO₃ powder includes, for example, CaCO₃ powder and ZrO₂ powder. The raw material of the SrZrO₃ powder includes, for example, SrCO₃ powder and ZrO₂ powder. The raw material of the SrTiO₃ powder includes, for example, SrCO₃ powder and TiO₂ powder. The raw material of the CaTiO₃ powder includes, for example, CaCO₃ powder and TiO₂ powder. Three or more types of powder selected from the CaCO₃ powder, the ZrO₂ powder, the SrCO₃ powder, and the TiO₂ powder may be mixed. The contents of Zr, Ti, Ca, and Sr in the ceramic are adjusted by adjusting the proportion of the CaZrO₃, SrZrO₃, SrTiO₃, and CaTio₃ powders.

Glass is added to the ceramic slurry for the dielectric sheets. Additives may be added to the ceramic raw material. Examples of the additives include B₂O₃, SiO₂, Li₂CO₃, BaCO₃, SrCO₃, and MgCO₃.

The ceramic slurry prepared to form the dielectric sheets includes ceramic slurry that serves as the material of the inner layer portion, the side gap portions, and the end gap portions (sometimes referred to as “first ceramic slurry”) and ceramic slurry that serves as the material of the outer layer portions (sometimes referred to as “second ceramic slurry”). The first ceramic slurry and the second ceramic slurry have different compositions. The content ratio of glass in the second ceramic slurry is at least higher than the content ratio of glass in the first ceramic slurry.

The first ceramic slurry is formed into the shape of sheets. Thus, dielectric sheets that serve as the material of the inner layer portion, the side gap portions, and the end gap portions (sometimes referred to as “first dielectric sheets”) are obtained. The second ceramic slurry is formed into the shape of sheets. Thus, dielectric sheets that serve as the material of the outer layer portions (sometimes referred to as “second dielectric sheets”) are obtained. Portions of the side gap portions that are next to the outer layer portions in the width direction W and portions of the end gap portions that are next to the outer layer portions in the length direction L are formed of the second dielectric sheets.

Subsequently, patterns of inner electrodes (sometimes referred to simply as “inner electrode patterns”) are printed on the first dielectric sheets with a conductive paste. The inner electrode patterns are formed by printing, for example, by screen printing, gravure printing, or relief printing. The inner electrode patterns, for example, have a rectangular shape when viewed in the lamination direction T. No inner electrode patterns are printed on the second dielectric sheets.

Subsequently, the first dielectric sheets are stacked. The first dielectric sheets are stacked such that the inner electrode patterns on the adjacent sheets are displaced from each other by one-half of the pitch in the length direction L. Subsequently, the second dielectric sheets are stacked on both sides of the stack of first dielectric sheets in the lamination direction T. The second dielectric sheets are bonded to the stack of first dielectric sheets by thermal pressure bonding. Thus, a mother block is obtained.

Each outer layer portion may be formed by laminating a plurality of second dielectric sheets or be formed of a single second dielectric sheet.

Subsequently, the mother block is cut along lines corresponding to the dimensions of the multilayer body 2. The mother block is, for example, cut along the length direction L and the width direction W. Thus, a plurality of rectangular-parallelepiped-shaped blocks (referred to as “multilayer chips”) are obtained. The corner portions and the ridge portions of the multilayer chips are preferably rounded by, for example, barrel finishing.

Subsequently, the multilayer chips are heated at a predetermined firing temperature for a predetermined time in a nitrogen atmosphere. Thus, the multilayer body 2 is obtained. The firing conditions are adjusted as appropriate to form the Zr-rich regions.

The dielectric sheets include Zr, an alkaline earth metal element (Ca or Sr), and glass. The multilayer chips are fired under firing conditions adjusted as appropriate so that, of Zr and the alkaline earth metal element, only the alkaline earth metal element moves toward the glass. Therefore, the ratio of Zr relative to the alkaline earth metal element increases in regions in which Zr and the alkaline earth metal element have existed. This causes segregation of Zr to form the Zr-rich regions in the dielectric body. The content ratio of glass in the second dielectric sheets is greater than the content ratio of glass in the first dielectric sheets. Accordingly, the area proportion of the Zr-rich regions in the outer layer portions can be greater than the area proportion of the Zr-rich regions in the inner dielectric layers.

Subsequently, the base electrode layers 31 are formed on the end surfaces C of the multilayer body 2. A conductive paste including glass and metal is applied to the multilayer body 2. The conductive paste is, for example, applied to extend from the end surfaces C to portions of the principal surfaces A and portions of the side surfaces B.

Subsequently, the multilayer body 2 on which the base electrode layers 31 are formed is heated at a predetermined firing temperature for a predetermined time in a nitrogen atmosphere. Thus, the base electrode layers 31 are baked on the multilayer body 2. The multilayer-body firing step and the base-electrode-layer baking step may be performed simultaneously after the material of the base electrode layers is applied to the multilayer chip.

Subsequently, the plating layers 32 are formed on the base electrode layers 31. First, the inner plating layers 321 are formed on the base electrode layers 31. Subsequently, the outer plating layers 322 are formed on the inner plating layers 321. The inner plating layers 321 are formed, for example, by Ni plating. The outer plating layers 322 are formed, for example, by Sn plating. The inner plating layers 321 and the outer plating layers 322 are, for example, successively formed by electrolytic plating.

The multilayer ceramic capacitor 1 illustrated in FIG. 1 is formed by the above-described method.

Multilayer ceramic capacitors were produced by the above-described manufacturing method as samples of experimental examples. The samples of experimental examples were subjected to various tests.

Multilayer ceramic capacitors having structures similar to that of the above-described multilayer ceramic capacitor 1 were produced as samples of experimental and comparative examples. The alkaline earth metal element included in the dielectric body was Ca. Experimental Examples 1 to 7 were prepared as experimental examples. Comparative Example 1 was prepared as a comparative example. Five hundred samples of multilayer ceramic capacitors were produced for each of the experimental and comparative examples.

For each of the experimental and comparative examples, the dimensions of the multilayer ceramic capacitors were L×W×T=0.33 mm×0.63 mm×0.22 mm.

The area ratio of the Zr-rich regions (that is, the area proportion of the inner-layer Zr-rich regions/area proportion of the outer-layer Zr-rich regions) differed for each of the experimental and comparative examples. The content ratio of glass in the dielectric sheets was adjusted to adjust the area of the Zr-rich regions in each of the experimental and comparative examples. More specifically, when the samples of the experimental examples were manufactured, the content ratio of glass in the first dielectric sheets and the content ratio of glass in the second dielectric sheets were both adjusted in the range of about 2% or more and about 12% or less, for example. The glass used included Ca. When the samples of the comparative example were manufactured, the content ratio of glass in the first dielectric sheets and the content ratio of glass in the second dielectric sheets were both about 1% or less, for example.

Subsequently, the produced samples were evaluated based on the results of measurement of the ratio of the area proportion of the inner-layer Zr-rich regions to the area proportion of the outer-layer Zr-rich regions (that is, the area ratio of the Zr-rich regions) and the occurrence rate of structural defects.

Each multilayer ceramic capacitor was polished to expose an LT cross section passing through a central portion in the width direction W. The exposed cross section was subjected to elemental analysis by TEM-EDX. The field of view was about 0.1 μm x about 0.1 μm. The analyzed elements were Zr and Ca.

The Zr-rich regions were defined as regions in which Zr and Ca were detected with the intensity of Ca being about ¼ or less of the maximum intensity of Zr, and which had a maximum region diameter of about 500 nm or more, for example. The area of the inner-layer Zr-rich regions was measured in the inner dielectric layers. The area of the inner-layer Zr-rich regions was divided by the area of the inner dielectric layers in the field of view to determine the area proportion of the inner-layer Zr-rich regions. The area of the outer-layer Zr-rich regions was measured in the outer layer portions. The area of the outer-layer Zr-rich regions was divided by the area of the outer layer portions in the field of view to determine the area proportion of the outer-layer Zr-rich regions. The area proportion of the inner-layer Zr-rich regions was divided by the area proportion of the outer-layer Zr-rich regions to determine the area ratio of the Zr-rich regions.

For each of the experimental and comparative examples, the area ratios of the Zr-rich regions in the 500 samples were measured. The area ratios of the Zr-rich regions in the samples were averaged for each of the experimental and comparative examples. The obtained average was determined as the area ratio of the Zr-rich regions for each of the experimental and comparative examples.

The LT cross section passing through the central portion of the multilayer body in the width direction was observed with an optical microscope. Samples with at least one of a separation between the inner and outer layer portions and a crack were determined to be defective. The number of defective samples among the 500 samples was defined as the occurrence rate.

Each of the experimental and comparative examples was evaluated as “good” when the number of defective samples among the 500 samples that deviated from the specified value of insulation resistance was 0, “fair” when the number was 1 or more and 10 or less, and “poor” when the number was 11 or more.

Table 1 shows the measurement result of the area ratio of the Zr-rich regions, the measurement result of the occurrence rate of structural defects, and the evaluation result for each of Comparative Example 1 and Experimental Examples 1 to 7.

TABLE 1

| | Area Ratio of Zr- | Occurrence | |
|---|---|---|---|
| | Rich Regions | Rate of | |
| | (Inner layer/Outer | Structural | Evaluation |
| | layer) | Defects | Result |
| Comparative | — | 12/500 | Poor |
| Example 1 | | | |
| Experimental | 0.010 | 2/500 | Fair |
| Example 1 | | | |
| Experimental | 0.050 | 0/500 | Good |
| Example 2 | | | |
| Experimental | 0.250 | 0/500 | Good |
| Example 3 | | | |
| Experimental | 0.500 | 0/500 | Good |
| Example 4 | | | |
| Experimental | 0.770 | 0/500 | Good |
| Example 5 | | | |
| Experimental | 0.900 | 0/500 | Good |
| Example 6 | | | |
| Experimental | 0.980 | 2/500 | Fair |
| Example 7 | | | |

No Zr-rich regions were found in Comparative Example 1. The occurrence rate of structural defects was relatively high in Comparative Example 1.

Experimental Examples 2 to 6 show that the occurrence of structural defects can be appropriately reduced when the area ratio of the Zr-rich regions is about 0.05 or more and about 0.9 or less, for example.

Experimental Example 1 shows that when the area ratio of the Zr-rich regions is less than about 0.01, the effect of reducing the occurrence of structural defects may be somewhat reduced. This may be because when the area proportion of the outer-layer Zr-rich regions is excessively higher than the area proportion of the inner-layer Zr-rich regions, the outer layer portions contract too easily compared to the inner dielectric layers.

Experimental Example 7 shows that when the area ratio of the Zr-rich regions is about 0.980 or more, the effect of reducing the occurrence of structural defects may be somewhat reduced. This may be because when the difference between the area proportion of the outer-layer Zr-rich regions and the area proportion of the inner-layer Zr-rich regions is too small, the contractibility of the outer layer portions is not sufficiently high relative to the contractibility of the inner dielectric layers.

The present example embodiment has the following effects.

According to the above-described example embodiment, the multilayer ceramic capacitor 1 includes the multilayer body 2 and the pair of outer electrodes 3. The multilayer body 2 includes the dielectric body 10 and the plurality of inner electrodes 15 laminated with the dielectric body 10 therebetween. The multilayer body 2 includes the first principal surface AA and the second principal surface AB that face each other in the lamination direction T, the first side surface BA and the second side surface BB that face each other in the width direction W orthogonal to the lamination direction T, and the first end surface CA and the second end surface CB that face each other in the length direction L orthogonal to the lamination direction T and the width direction W. The outer electrodes 3 are arranged in the length direction L as a pair and connected to the inner electrodes 15. The multilayer body 2 includes the inner layer portion 11 and the pair of outer layer portions 12 between which the inner layer portion 11 is disposed in the lamination direction T. The inner layer portion 11 includes the effective portions 15a, which are portions of adjacent ones of the inner electrodes 15 that face each other, and the inner dielectric layers 14, which are portions of the dielectric body 10 that are between adjacent ones of the effective portions 15a. The dimension of the multilayer body 2 in the width direction W is greater than the dimension of the multilayer body 2 in the length direction L. The inner electrodes 15 include Cu. The dielectric body 10 includes Zr and an alkaline earth metal element that is at least one of Ca or Sr. The inner dielectric layers 14 include the inner-layer Zr-rich regions RA1. The outer layer portions 12 include the outer-layer Zr-rich regions RA2.

According to this structure, the multilayer ceramic capacitor 1 is an LW-reversed multilayer ceramic capacitor in which the dimension of the multilayer body 2 in the width direction W is greater than the dimension of the multilayer body 2 in the length direction L. Thus, the distance between the outer electrodes 3 can be reduced to shorten the current path, and the dimensions of the outer electrodes 3 and the inner electrodes 15 in the width direction W can be increased to widen the current path, so that ESL can be reduced.

The inner electrodes 15 include Cu. Since Cu has a relatively low specific resistance, the ESR can be reduced.

The dielectric body 10 includes Zr and an alkaline earth metal element that is at least one of Ca or Sr. Thus, the dielectric loss can be reduced.

Accordingly, the high frequency characteristics can be improved.

The inner dielectric layers 14 include the inner-layer Zr-rich regions RA1, and the outer layer portions 12 include the outer-layer Zr-rich regions RA2. The greater the area of the Zr-rich regions RA in a region, the more easily the region contracts. Therefore, the balance between the contractibility of the inner dielectric layers 14 and the contractibility of the outer layer portions 12 can be adjusted by adjusting the area of the inner-layer Zr-rich regions RA1 and the area of the outer-layer Zr-rich regions RA2. Thus, the inner layer portion 11 and the outer layer portions 12 can contract in a similar manner, thus reducing the occurrence of structural defects.

According to the above-described example embodiment, the alkaline earth metal element is Ca, and the dielectric body 10 includes a compound oxide including Zr and Ca.

According to this structure, the ESR can be appropriately reduced. The occurrence of structural defects can also be appropriately reduced.

In the above-described example embodiment, the alkaline earth metal element may be Sr. The dielectric body 10 may include a compound oxide including Zr, Ti, and Sr. The content ratio of Zr in the dielectric body 10 may be greater than the content ratio of Ti in the dielectric body 10.

According to this structure, when the dielectric body 10 includes a compound oxide including Ti and the alkaline earth metal element, the occurrence of structural defects can be appropriately reduced.

According to the above-described example embodiment, the dielectric body 10 includes at least one of Li, Na, Mn, B, or Si.

According to this structure, the temperature at which the dielectric body 10 is sintered is reduced. In addition, the amount of glass to be added to reduce the temperature at which the dielectric body 10 is sintered can be reduced, so that the mechanical strength of the dielectric body 10 can be easily ensured.

According to the above-described example embodiment, the outer electrodes 3 (more specifically, the base electrode layers 31) include Cu.

According to this: structure, since Cu has a low electrical resistance and the conductor loss due to the conductor is small, the loss of the multilayer ceramic capacitor 1 can be further reduced.

According to the above-described example embodiment, the area of the inner-layer Zr-rich regions RA1 per unit area of the inner dielectric layers 14 is less than the area of the outer-layer Zr-rich regions RA2 per unit area of the outer layer portions 12.

According to this structure, the contractibility of the inner layer portion can be reduced by reducing the area proportion of the inner-layer Zr-rich regions. The contractibility of the outer layer portions can be increased by increasing the area proportion of the outer-layer Zr-rich regions. Although the inner dielectric layers tend to contract more easily than the outer layer portions, the difference in contractibility between the inner dielectric layers and the outer layer portions can be reduced. Thus, the occurrence of structural defects due to the difference in contractibility between the inner dielectric layers and the outer layer portions can be reduced.

According to the above-described example embodiment, the ratio of the area of the inner-layer Zr-rich regions RA1 per unit area of the inner dielectric layers 14 to the area of the outer-layer Zr-rich regions RA2 per unit area of the outer layer portions 12 is about 0.05 or more and about 0.9 or less, for example.

According to this structure, the occurrence of structural defects can be appropriately reduced.

Although example embodiments of the present invention have been described, the present invention is not limited to the above-described example embodiments, and various alterations, modifications, and combinations are possible.

The side gap portions 13S may be formed of dielectric sheets for side gap portions (sometimes referred to as “third dielectric sheets”). In such a case, in the cutting step, the mother block is cut so that the conductive paste is exposed at the end surfaces and the side surfaces of each multilayer chip. The third dielectric sheets are bonded to the side surfaces of the multilayer chip. The conductive paste exposed at the side surfaces of the multilayer chip is covered with the third dielectric sheets. The third dielectric sheets serve as the side gap portions after being sintered. The side gap portions may be formed by laminating a plurality of third dielectric sheets or be formed of a single third dielectric sheet.

The composition of the ceramic slurry for the third dielectric sheets (sometimes referred to as “third ceramic slurry”) is, for example, the same as the composition of the first ceramic slurry. However, the composition of the third ceramic slurry is not limited to this, and may be the same as the composition of the second ceramic slurry or differ from both the composition of the first ceramic slurry and the composition of the second ceramic slurry. The manner in which the side gap portions contract can be adjusted by adjusting the composition of the third ceramic slurry.

When the outer layer portions are formed by laminating a plurality of second dielectric sheets, one outer layer portion may include a plurality of second dielectric sheets having different compositions. When one outer layer portion includes second dielectric sheets having different compositions, the contractibility of the outer layer portion can be locally adjusted. This also applies to when the side gap portions are formed by laminating a plurality of third dielectric sheets.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a dielectric body and a plurality of inner electrodes laminated with the dielectric body therebetween, the multilayer body including a first principal surface and a second principal surface that face each other in a lamination direction, a first side surface and a second side surface that face each other in a width direction orthogonal to the lamination direction, and a first end surface and a second end surface that face each other in a length direction orthogonal to the lamination direction and the width direction; and
a pair of outer electrodes arranged in the length direction as a pair, each of the outer electrodes being connected to the inner electrodes; wherein
the multilayer body includes an inner layer portion and a pair of outer layer portions between which the inner layer portion is arranged in the lamination direction, the inner layer portion including effective portions, which are portions of adjacent ones of the inner electrodes that face each other, and an inner dielectric layer, which is a portion of the dielectric body between adjacent ones of the effective portions;
a dimension of the multilayer body in the width direction is greater than a dimension of the multilayer body in the length direction;
the inner electrodes include Cu;
the dielectric body includes Zr and an alkaline earth metal element that is at least one of Ca or Sr;
the inner dielectric layer includes inner-layer Zr-rich regions; and
the outer layer portions include outer-layer Zr-rich regions.

2. The multilayer ceramic capacitor according to claim 1, wherein
the alkaline earth metal element is Ca; and
the dielectric body includes a compound oxide including Zr and Ca.

3. The multilayer ceramic capacitor according to claim 1, wherein
the alkaline earth metal element is Sr;
the dielectric body includes a compound oxide including Zr, Ti, and Sr; and
a content ratio of Zr in the dielectric body is greater than a content ratio of Ti in the dielectric body.

4. The multilayer ceramic capacitor according to claim 1, wherein the dielectric body includes at least one of Li, Na, Mn, B, or Si.

5. The multilayer ceramic capacitor according to claim 1, wherein the outer electrodes include Cu.

6. The multilayer ceramic capacitor according to claim 1, wherein an area of the Zr-rich regions per unit area of the inner dielectric layer is less than an area of the Zr-rich regions per unit area of the outer layer portions.

7. The multilayer ceramic capacitor according to claim 1, wherein a ratio of an area of the Zr-rich regions per unit area of the inner dielectric layer to an area of the Zr-rich regions per unit area of the outer layer portions is about 0.05 or more and about 0.9 or less.

8. The multilayer ceramic capacitor according to claim 1, wherein the multilayer ceramic capacitor is a two-terminal multilayer ceramic capacitor.

9. The multilayer ceramic capacitor according to claim 1, wherein the multilayer ceramic capacitor is a an LW-reversed multilayer ceramic capacitor.

10. The multilayer ceramic capacitor according to claim 1, wherein a dimension of the multilayer body in the length direction is about 0.2 mm or more and about 2.2 mm or less, a dimension of the multilayer body in the width direction is about 0.1 mm or more and about 1.5 mm or less, and a dimension of the multilayer body in the lamination direction is about 0.1 mm or more and about 1.0 mm or less.

11. The multilayer ceramic capacitor according to claim 1, wherein the multilayer body includes rounded corner portions or rounded ridge portions.

12. The multilayer ceramic capacitor according to claim 1, wherein the Zr-rich regions are regions in which both Zr and the alkaline earth metal element are included, and a content of the alkaline earth metal element is about ¼ or less of a content of Zr.

13. The multilayer ceramic capacitor according to claim 1, wherein the Zr-rich regions are regions having a maximum region diameter of about 500 nm or more.

14. The multilayer ceramic capacitor according to claim 1, wherein the Zr-rich regions are regions in which both Zr and the alkaline earth metal element are included and a content of the alkaline earth metal element is about ¼ or less of a content of Zr, and a maximum region diameter is about 500 nm or more.

15. The multilayer ceramic capacitor according to claim 2, wherein the compound oxide has a composition represented by (Ca₁₋ₓ, Srₓ)ₘ(Zr_{1-z}, Ti_{z})O₃, where x is 0 or more and 1 or less, m is 1.0 or more and 1.1 or less, and z is about 0 or more and about 0.2 or less.

16. The multilayer ceramic capacitor according to claim 2, wherein the inner dielectric layer includes a compound oxide including Zr and Ca.

17. The multilayer ceramic capacitor according to claim 2, wherein the outer layer portions include a compound including Zr and Ca.

18. The multilayer ceramic capacitor according to claim 2, wherein the inner dielectric layer includes a compound oxide including Zr, Ti, and Sr.

19. The multilayer ceramic capacitor according to claim 18, wherein the outer layer portions include a compound oxide including Zr, Ti, and Sr.

20. The multilayer ceramic capacitor according to claim 19, wherein a content ratio of Zr in the inner dielectric layer is greater than a content ratio of Ti in the inner dielectric layer, and a content ratio of Zr in the outer layer portions is greater than a content ratio of Ti in the outer layer portions.
